(19) United States
(12) Patent Application Publication
(10) Pub. No.: US 2017/0283306 A1
(43) Pub. Date: Oct. 5, 2017

(54) GLASS COMPOSITE SUITABLE FOR PROVIDING A PROTECTIVE COATING ON UNTREATED SUBSTRATES

(71) Applicant: Prince Minerals LLC, Houston, TX (US)

(72) Inventors: Christian Schlegel, Houston, TX (US); Jon Davies, Kingwood, TX (US); Mike Koenigstein, Houston, TX (US)

(73) Assignee: Prince Minerals LLC, Houston, TX (US)

(21) Appl. No.: 15/315,282

(22) PCT Filed: May 12, 2015
(86) PCT No.: PCT/US2015/030321

§ 371 Date: Nov. 30, 2016

Related U.S. Application Data
(60) Provisional application No. 61/991,890, filed on May 12, 2014.

(51) Int. Cl. C03C 3/118; C23D 5/04; C03C 8/06; C03C 8/02; C03C 8/22; C03C 3/095

(52) U.S. Cl. CPC C03C 3/118; C03C 8/22; C03C 3/095; C03C 8/06; C03C 8/02; C23D 5/04

(57) ABSTRACT

Glass composite coating systems herein may be used for industrial applications serving as a chemical barrier against substrate oxidation or other deterioration by corrosive agents, may prevent material build-up in process piping and equipment, may provide for improved bonding strength between concrete and reinforcing media, and may inhibit microbial build-up on exposed surfaces. Traditionally, glass coatings are emplaced on relatively pristine, pre-prepared surfaces. Glass composite coating systems described herein may be bonded to untreated substrates, without the need to clean, polish and/or pre-treat the substrate.

### FIELD OF THE DISCLOSURE

Embodiments disclosed herein relate generally to coatings for ferrous and non-ferrous substrate materials, and more particularly to glass composite coating systems suitable for construction materials (such as rebar, steel fiber, structural steel, steel piping, etc.), consumer products (e.g., cookware, etc.) and durable goods (e.g., clothes- and dish-washers, ovens, oven racks, etc.). Even more particularly, embodiments of the glass composite coating systems disclosed herein may be bonded to untreated substrates, such as those noted above, without the need to clean, polish and/or pre-treat the substrate.

### BACKGROUND

Process and construction materials known in the art are typically exposed to conditions and/or environments that may result in corrosion, deterioration in structural integrity and/or contamination with microbes or chemical contaminants. As a result, useful life may be negatively impacted, structural integrity may be compromised, or premature failure may occur.

For instance, process piping used in the oil, gas and chemical industries may experience a build-up of deposits from the material being transported that results in friction, high pressure drop and/or blockage causing high pumping costs and equipment down time for cleaning or replacement. Further, internal piping corrosion caused by transported material and/or external corrosion from environmental conditions may result in reduced useful life and increase the risk of a release. Methods known in the art attempting to address such problems include the use of galvanized, aluminized or organic coatings on ferrous and non-ferrous substrates. Problematically, such methods provide inadequate and limited substrate protection upon prolonged exposure to contained and transported materials, and to environmental conditions.

Further, concrete reinforced with rebar or similar structures (such as fibers) known in the art tends to fracture or spall over time, and weak bond strength between the reinforcing members and concrete may result in inferior resistance to forces generated by impact, earthquakes or explosions. Consequently, premature structural damage, considerable debris and/or material projectiles may result upon exposure to a catastrophic event, such as an explosion. Yet further, modern high rise buildings are typically constructed by pouring concrete over structural steel. Insufficient bond strength between the concrete and steel can result in delamination and compromised structural integrity. Steel corrosion by exposure to salts or other chemical compounds that may penetrate the concrete such as through cracks, may further compromise structural integrity. Such corrosion issues may be particularly acute in northern climates where the use of deicing salts are common and in marine climates where exposure to salt water is common.

In some applications, such as in waste water treatment, in industries having process streams containing significant content of biologically active organic matter characterized by a high biological oxygen demand or in biomedical applications, algae and/or bacterial growth may coat the piping, equipment, and apparatus. Problematically, cleaning or decontamination cycles are required to remove the contamination.

### SUMMARY OF THE DISCLOSURE

Embodiments disclosed herein provide for glass composite coating systems that may serve as a chemical barrier against substrate oxidation or other deterioration by corrosive agents, may prevent material build-up in process piping and equipment, may provide for improved bonding strength between concrete and reinforcing media, and may inhibit microbial build-up on exposed surfaces. Such glass composite coating systems may be bonded to untreated substrates, such as those noted above, without the need to clean, polish and/or pre-treat the substrate.

In one aspect, embodiments disclosed herein relate to a process for emplacing a glass coating on a substrate. The process may include: applying a glass coating system to at least one surface of a non-treated substrate; and sintering the glass coating system to form a glass coating therefrom on the at least one surface of the substrate.

In another aspect, embodiments disclosed herein relate to a glass composite or glass coating system. The glass composite or glass coating system may include: (1) from about 5 wt % to about 21 wt %, from about 6 wt % to about 16 wt %, or from about 7 wt % to about 13.5 wt % B₂O₃, (2) from about 1 wt % to about 7 wt %, from about 4 wt % to about 7 wt %, from about 1 wt % to about 6.5 wt %, from about 2.5 wt % to about 6.5 wt %, from about 3.5 to about 6.5 wt %, from about 1.5 wt % to about 4 wt %, or from about 2 wt % to about 3.5 wt % Li₂O, (3) from about 4 wt % to about 22 wt %, from about 6 wt % to about 18 wt %, or from about 7.5 wt % to about 16 wt % Na₂O and (4) from about 46 wt % to about 65 wt %, from about 49 wt % to about 61 wt %, from about 54 wt % to about 61 wt %, or from about 52 wt % to about 58 wt % SiO₂.

In another aspect, embodiments disclosed herein relate to a glass composite composition formed from at least two frits or powders comprising a primary fit or powder and a first secondary frit or powder. The primary frit or powder corresponds to the composition as described above. The first secondary frit or powder has an average particle size of from about 10μ to about 100μ and comprises (a) from about 37 wt % to about 48 wt % SiO₂, (b) from about 1.5 wt % to about 5 wt % MoO₃, (c) from about 3 wt % to about 11 wt % Li₂O, (d) from about 2 wt % to about 7 wt % F₂, (e) from about 4 wt % to about 8.5 wt % CaO, and (f) from about 5 wt % to about 14 wt % B₂O₃. The glass composite composition may include from 15 wt % to about 35 wt % or from about 20 wt % to about 22 wt % of the first secondary fit or powder.

In another aspect, embodiments disclosed herein relate to a coated article comprising a ferrous or non-ferrous substrate and a glass composite formed from the composition or coating systems according to any one of the embodiments described above deposited on at least one surface of the substrate.

In another aspect, embodiments disclosed herein relate to a reinforced concrete structure comprising concrete and rebar contained within the structure wherein the rebar is coated with the glass composite composition or coating systems according to any one of the embodiments described above.

In another aspect, embodiments disclosed herein relate to a method for coating a ferrous or non-ferrous substrate with a glass composite. The method may include comprising (i) applying a composition or coating systems according to any one of the embodiments described above to at least one surface of a ferrous or non-ferrous substrate, and (ii) sintering the frit composition to form the glass composite therefrom on the at least one surface of the substrate.

Other aspects and advantages will be apparent from the following description and the appended claims.

### DETAILED DESCRIPTION

Embodiments herein are directed toward glass coating systems, which may also be referred to herein as enamel coating systems, for use in industrial applications. Glass coating systems herein may be formed from a single composition, such as a frit or powder, or may be formed from two or more compositions, such as two or more fits or powders in admixture. As described later, these glass coating systems may be applied to a surface of a substrate via wet or dry processes and then fired to bond the coating to the substrate.

Prior to emplacing a coating on a substrate, it is routine industry practice to pre-treat or prepare the surface of the substrate such that the coating may be applied and bonded to a surface largely representative of the underlying substrate. Prior to coating a steel substrate, for example, it is routine industry practice to chemically and/or mechanically treat the surface of the steel substrate to remove rust and other surface imperfections, such that the coating may be applied to a cleaned and polished surface of the steel. Before the application of an enamel coating, the surface of the substrate is cleaned to remove chemicals, rusts, oils, and other contaminants. Complete removal of these contaminants is considered necessary by those skilled in the art, and is facilitated by processes such as degreasing, pickling, alkaline neutralization, and rinsing.

In direct contrast to standard industry practice, it has been found that glass coating systems described herein may be applied to a substrate surface that has not been pre-treated. For a steel substrate, for example, coating systems according to embodiments herein may be applied to a surface of the steel substrate, where the surface of the steel substrate has not been pre-treated to remove rust or other surface imperfections. Theorizing, it is believed that the chemical nature of the coating systems disclosed herein provides for a significant bonding effect with the surface of the substrate, even with the surface imperfections present. For a non-treated steel substrate, for example, glass coating systems disclosed herein may interact with the ferrous oxides present on the surface of the steel substrate, forming a relatively strong bond between the coating and the surface of the steel. In some embodiments, glass coating systems disclosed herein may incorporate or tolerate other surface imperfections, such as an amount of grease or dirt present on the surface of the substrate when coated, forming a relatively strong bond between the coating and the surface of the substrate.

Glass coating systems disclosed herein may also be applied to a pre-treated surface, and may form a bond of sufficient strength with the pre-treated surface. However, as the pre-treatment of substrates is an expensive and time consuming process step, the benefits of the glass coating systems disclosed herein may be used to eliminate this costly standard industry process step, if desired, without detriment to the properties of the final coated product.

Embodiments disclosed herein may thus include processes for emplacing a glass coating on a substrate. The process may include applying a glass coating system to at least one surface of a ferrous or non-ferrous substrate, where the surface of the substrate is not pre-treated prior to applying the glass coating system. As used herein, “not pre-treated,” “non-treated” and similar terms refer to the absence of a distinct process step in which the surface of the substrate is prepared prior to application of the glass coating system, such as by a chemical or physical treatment to remove surface rust, polishing, or other typical practices for preparing a surface to be coated. In some embodiments, the substrate may be washed, such as to remove dirt, dust, or grease, however some glass coating compositions disclosed herein may even tolerate the presence of some amount of dirt, dust, and grease without significant detriment to the final coating properties.

Restating the above, embodiments disclosed herein may thus include processes for emplacing a specially designed glass coating on a non-treated substrate. The process may include applying a glass coating system to at least one surface of a ferrous or non-ferrous substrate, where the surface of the substrate at the time of application contains surface imperfections. As used herein, “surface imperfections” and similar terms refer to the presence of an amount of rust or metal oxides, and possibly dirt or grease, on the surface of the substrate or forming an outer layer of the substrate, that are typically removed from the surface of a substrate in a distinct process step in which the surface of the substrate is prepared for application of the glass coating system, such as degreasing, pickling, sandblasting, or other chemical or physical treatments to remove surface rust, polishing, or other typical practices for preparing a surface to be coated.

Following application, the glass coating system may be sintered to form a glass coating therefrom on the surface of the substrate. As used herein, “sintered,” “sintering” and similar terms, such as “fired” or “firing,” refer to a process for transforming the glass coating system to a cohesive glass composite structure bonded to the surface of the substrate. Sintering may thus refer to heat treatment, electrical resistivity treatment, or other methods for converting a glass coating system to a glass composite structure.

As noted above, coated substrates having glass coatings according to embodiments herein may be formed without pre-treatment of the substrate (i.e., with the surface imperfections present). For example, steel, such as structural steel or rebar, may be stored in an open area or a semi-open area that may expose the steel to the environment. As a result, some rust may form on the outer surfaces of the steel prior to the steel being coated. Embodiments herein may thus allow the application and sintering of the glass coating system to the steel without a need for the rust to be removed from the steel or for the steel to be polished. It has thus been discovered that glass composites, formed from one or more glass coating systems according to embodiments herein, may provide a coating for ferrous and non-ferrous substrates including surface imperfections, such as rust or other normally undesirable metal oxides.

The glass coating systems herein, as described above, may thus be bonded to the surface of the substrate to provide a chemical barrier against substrate oxidation or other deterioration by corrosive agents, may prevent material build-up in process piping and equipment, and may inhibit microbial build-up on exposed surfaces.

In various applications, the coated substrate may also be used in conjunction with or contained within a matrix material. For example, structural steel or rebar may be contained within a cement matrix. In some embodiments, the glass coating systems herein may provide for bonding with both the substrate surface and the matrix. For example, glass coating systems herein may be used to provide a steel reinforced cement structure, where the glass coating system enhances the overall structure with minimal or no delamination of the cement matrix from the substrate. The glass coating system, as described above, may thus be bonded to the surface of a substrate, not pre-treated, to provide for improved bonding strength between a matrix material, such as concrete, and a reinforcing media, such as rebar or structural steel. Improved bonding may allow for improving anti-corrosive properties and bonding of rebar, as well as for usage in blast-resistant concrete structures, for example.

As noted above, glass coating systems herein may include two or more fits or powders in admixture. In some embodiments, the glass coating system may be formed by admixing two or more powders or frits to form the glass coating system, where the powders or fits are selected, measured, and admixed to form a glass coating system that provides both the desired bonding properties with the substrate and the desired properties of the coating, such as for providing weather or chemical resistance, a self-healing glass, or other desired characteristics of the final coated product.

In other embodiments, methods according to embodiments herein may include application of a ground coat and a cover coat, such as where the ground coat is a glass coating system as described herein, and is applied to the substrate, followed by application of one or more cover coats. The one or more cover coats, for example, may be provided to form a compatibilizing layer between the glass coating system and the matrix material. The sintering of the base and cover coats may thus provide for a glass coating composition having an inner layer, formed from a glass coating system according to embodiments herein that is well suited for bonding to a substrate surface, and an outer layer, formed from a fit or powder composition that is well suited for bonding to the matrix material. It is noted that the sintering process may result in some blending of the base coat and cover coat proximate the interface(s) of the compositions; however such blending of the layers forms a contiguous structure, where the properties of the contiguous structure proximate the substrate differ from the properties of the contiguous structure that are to be disposed proximate the matrix material. When multiple layers or coats are applied to form the glass coating system, the system may be formed by a multiple coat one-fire process or may be formed by a multiple coat multiple fire process.

To form the glass coating systems suitable for use with non-treated substrates, various components are admixed to form a mixture or a slurry. Accordingly, processes disclosed herein may include admixing one or more components, such as those described below, to form a glass coating system, prior to application of the glass coating system to the substrate.

Glass coating systems disclosed herein may include silicate compounds that may include one or more of: alkali metal compounds, alkaline earth metal compounds, compounds to provide acid, alkali, or water resistance, iron-oxide bond-enhancing components, wetting compounds or wetting agents, alkali equilibrium stabilizers, sources of phosphate ions, and sources of calcium ions, among other components. Such glass coating systems provide a coating for steel (ferrous and non-ferrous) substrates such as construction materials, consumer products and durable goods that provides for improved corrosion resistance, improved resistance to buildup of chemical and microbial deposits, improved bond strength between concrete and associated reinforcing members, and improved glass sealing (healing) properties. In some aspects of the present disclosure, the glass coating systems adequately bond to the substrate in the absence of prior substrate pre-treatment.

As used herein, “construction materials” are defined broadly and include, for example and without limitation, any steel article such as process piping, process equipment, concrete, structural steel, and concrete reinforcing members such as rebar, fibers and mesh, as well as masonry ties and anchors. As used herein, “ferrous substrate” is defined broadly as containing at least 50 wt % iron and “non-ferrous substrate” is defined broadly as containing less than 50 wt % iron and includes, for instance and without limitation, stainless steel and aluminum. As used herein, “consumer products” and “durable goods” are defined broadly and include, for example and without limitation, any article containing ferrous or non-ferrous substrates, such as cookware, clothes- and dish-washers, ovens, oven racks, automobile parts, or generally, any metallic based article that is subject to degradation or corrosion in response to thermal stress and/or chemical attack. As used herein, “porcelain” and “porcelain enamel” are broadly defined as glass materials fused to a substrate.

In any of the various aspects of the disclosure, glass coatings may be formed from one or more glass coating systems disclosed herein, and may be formed from a variety of enamel systems including those based on frits and powders. Formation of frits is generally known in the art, as is the formation of powders; it is the specific compounds used in the glass coating systems herein that differentiates them over systems that cannot properly bond with untreated substrates. Frits and powders, for instance, and without being bound to any particular formation method, may be formed by sintering together the various components of the glass coating system, followed by cooling and milling to form the frits or powders.

In some aspects, the various components of the glass coating system may be first blended to form a mixture. The mixture may then be placed in a high temperature furnace, such as a rotary furnace or a continuous furnace, wherein the contents are heated to above the melting temperature, typically from about 1000° C. to about 1400° C., although temperatures outside this range are within the scope of the present disclosure. The contents are held at temperature for a time sufficient to assure melting and the formation of a generally homogeneous admixture, typically from about 1 hour to about 2 hours, although melting times outside this range are within the scope of the present disclosure. In some aspects, the melt is then cooled. For a batch type process, the melt may be transferred to a quenching and drying vat, for example; for a continuous process, the melt may be passed through cooling rollers, for example. The cooled glass composition is then reduced in size, such as by passing the cooled glass from the cooling rolls through a crusher, where the glass composition is crushed to form chips or flakes having a size in the largest dimension of, typically, from about 0.1 cm to about 10 cm; when powders are desired, the chips or flakes may be reduced in size, such as by granulation in a wet grinding or milling process. In any of the various aspects, and depending upon the type of furnace used, cleaned glass monoliths, glass chips or granulated glass (e.g., granulates or flakes) may be subjected to particle size reduction according to attrition methods known in the art, such as, for instance, ball mills, to produce a frit or powder of the desired particle size. In some aspects, such as when the glass coating system is in the form of a powder, the average particle size of the powder is about 1 micron, about 5 microns, about 10 microns, about 25 microns, about 50 microns, about 75 microns, about 100 microns, and ranges thereof, such as from about 1 to about 100 microns, from about 1 to about 50 microns, from about 1 to about 25 microns, from about 5 to about 25 microns or from about 1 to about 10 microns.

The compositional characteristics of glass coating systems of embodiments disclosed herein are described in Table A, below, where the concentrations ranges are reported in percent by weight of the composition.

TABLE A
Primary components of glass coating systems
according to embodiments herein

| Component | First Range | Second Range | Third Range |
|---|---|---|---|
| Na₂O | 4 to 22 wt % | 6 to 18 wt % | 7.5 to 16 wt % |
| Li₂O | 1 to 7 wt % | 1.5 to 4 wt % | 2 to 3.5 wt % |
| B₂O₃ | 5 to 21 wt % | 6 to 16 wt % | 7 to 13.5 wt % |
| SiO₂ | 46 to 65 wt % | 49 to 61 wt % | 52 o 58 wt % |

In some other aspects of the present disclosure, the concentration range of Li₂O is from about 4 to about 7 wt %, from about 1 to about 6.5 wt %, from about 2.5 to about 6.5 wt %, or from about 3.5 to about 6.5 wt %. In yet other aspects of the present disclosure, the SiO₂ concentration range is from about 54 to about 61 wt %. In any of the various aspects of the present disclosure the ratio of Li₂O to SiO₂ on a wt % basis is about 0.01:1, about 0.02:1, about 0.03:1, about 0.04:1, about 0.05:1, about 0.06:1, about 0.07:1, about 0.08:1, about 0.09:1, about 0.1:1, about 0.11:1, about 0.12:1, about 0.13:1, about 0.14:1, or about 0.2:1, and ranges thereof, such as from about 0.01:1 to about 0.2:1, from about 0.015:1 to about 0.15:1, from about 0.02:1 to about 0.08:1, or from about 0.03:1 to about 0.07:1.

In some other aspects of the present disclosure, the glass coating system suitably comprises one or more alkali metal compounds that are capable of forming or enhancing a bond with iron oxides, such as FeO, thereby providing for improved bond strength between the glass composite compositions and ferrous and certain non-ferrous substrates (i) that have been conventionally pre-treated by degreasing, pickling and/or by shot blasting or (ii) that have not been subjected to pre-treatment. It is believed, without being bound to any particular theory, that the FeO binding compounds form an interfacial bonding layer through their exchanges with FeO appearing during the oxidation phase of the substrate. In some aspects, the glass coating system can further include, or may be combined with, a secondary frit or powder including one or more alkali metal compounds that enable porcelain enamels to be formed without any required metallic substrate preparation. For instance, surface contaminants such as greases, oil or metal oxides (rust) need not be removed (e.g., grease removal with solvent and/or metal oxide removal by acid treatment, abrasion and/or etching). In another bonding mechanism, it is believed that for non-ferrous substrates having some amount of iron alloyed with other elements, such as stainless steel further comprising Ni, at least some of the iron and other elements go into solution and form a bond with the glass composite. In such aspects, any compound listed in Table B, or combinations thereof, can be added to the glass coating system, or combined with the primary components of the glass coating system, in order to allow the glass composite to adhere to a metal substrate without metal surface preparation, wherein the concentration ranges refer to the final concentration in the overall glass coating system from which the glass composite is formed.

TABLE B

| Com- | First | Second | Third | Fourth |
|---|---|---|---|---|
| ponent | Range | Range | Range | Range |
| CeO₂ | 0 to 4 wt % | 0.1 to 3.5 wt % | 0.3 to 3 wt % | 0.5 to 2.8 wt % |
| CoO | 0 to 7 wt % | 0.2 to 5 wt % | 0.2 to 4 wt % | 0.4 to 3 wt % |
| CuO | 0 to 4 wt % | 0.1 to 3.5 wt % | 0.3 to 3 wt % | 0.5 to 2.2 wt % |
| MnO | 0 to 9 wt % | 0.2 to 6.5 wt % | 0.5 to 4.8 wt % | 0.8 to 3.5 wt % |
| NiO | 0 to 6 wt % | 0.05 to 5 wt % | 0.05 to 3.5 wt % | 0.05 to 2.8 wt % |
| Sb₂O₃ | 0 to 3 wt % | 0.05 to 2 wt % | 0.05 to 1.5 wt % | 0.1 to 1 wt % |
| MoO₃ | 0 to 7 wt % | 0.2 to 6 wt % | 0.5 to 4.5 wt % | 0.5 to 4 wt % |
| WO₃ | 0 to 4 wt % | 0.1 to 3.5 wt % | 0.1 to 3 wt % | 0.5 to 2.8 wt % |

In some aspects of the disclosure, the glass coating system includes (i) MoO₃ and (ii) CoO, MnO or a combination thereof. In other aspects, the glass coating system includes (i) MoO₃, (ii) CoO, MnO or a combination thereof and (iii) NiO, CeO₂, CuO or a combination thereof. It is believed that MoO₃ provides both oxide bonding capability and surface tension modifying properties as described herein.

In some particular aspects of the present disclosure, the concentration range of MoO₃ is from about 0.2 to about 5 wt %, or from about 3 to about 6 wt %. In one particular aspect based on experimental evidence to date, a glass coating system including from about 4 to about 7 wt % Li₂O in combination with from about 3 to about 6 wt % MoO₃ provides for effective coating (enameling) of a substrate in the absence of substrate pre-treatment.

In some other aspects of the present disclosure, the glass coating system suitably comprises one or more compounds listed in Table C that are capable of providing resistance to water and/or to alkali, wherein the concentration ranges refer to the final concentration in the glass coating system from which the glass composite is formed.

TABLE C

| Com- | First | Second | Third | Fourth |
|---|---|---|---|---|
| ponent | Range | Range | Range | Range |
| Al₂O₃ | 0.1 to 3 wt % | 0.5 to 3 wt % | 0.1 to 1.8 wt % | 0.1 to 1 wt % |
| CaO | 0.5 to 8.5 wt % | 1.5 to 7 wt % | 2 to 5 wt % | — |
| ZrO₂ | 0.5 to 9 wt % | 2 to 9 wt % | 0.5 to 5.5 wt % | 0.5 to 5 wt % |
| Fe₂O₃ | 0.1 to 5.5 wt % | 0.6 to 4.2 wt % | — | — |
| ZnO | 0.1 to 3 wt % | 0.5 to 2.2 wt % | — | — |

In some aspects of the disclosure, the glass coating system includes CaO, ZrO₂, Fe₂O₃ or a combination thereof. In some other aspects, the glass coating system includes comprises (i) CaO, ZrO₂, Fe₂O₃ or a combination thereof and (ii) Al₂O₃, ZnO, or a combination thereof. It is believed that CaO provides both resistance to water and/or alkali and is a component of the self-healing phase of apatite and fluoroapatite as described herein. It is further believed that Fe₂O₃ provides both resistance to water and/or alkali and oxide bonding capability.

In aspects of the present disclosure wherein the NiO concentration is less than about 1 wt %, less than about 0.5 wt %, less than about 0.1 wt %, or in essentially Ni-free compositions, the Fe₂O₃ concentration is suitably from about 0.1 to about 5.5 wt % or from about 0.6 to about 4.2 wt %. In some further aspects, improved alkaline and water-vapor resistance can be achieved in glass coating systems including from about 2 to about 9 wt % ZrO₂ and from about 0.5 to about 3 wt % Al₂O₃.

In some aspects of the present disclosure, the glass coating system includes from about 3 wt % to about 9 wt %, from about 4.5 wt % to about 9 wt %, from about 3 wt % to about 6.5 wt %, or from about 3 wt % to about 6 wt % TiO₂ to enhance the acid resistance properties of the glass composite compositions, wherein the concentration ranges refer to the final concentration in the glass coating system from which the glass composite is formed. In some further aspects, improved acid resistance can be achieved in glass composite compositions comprising from about 54 to about 61 wt % SiO₂, from about 2.5 to about 6.5 wt % Li₂O and from about 4.5 to about 9 wt % TiO₂.

In some other aspects of the present disclosure, the glass coating system suitably comprises one or more wetting compounds listed in Table D, wherein the concentration ranges refer to the final concentration in the glass coating system from which the glass composite is formed.

TABLE D

| Com- | First | Second | Third | Fourth |
|---|---|---|---|---|
| ponent | Range | Range | Range | Range |
| F₂ | 0 to 9 wt % | 0.5 to 8.5 wt % | 0.5 to 6 wt % | 0.7 to 5 wt % |
| V₂O₅ | 0 to 5 wt % | 0.1 to 5 wt % | 2 to 5 wt % | — |
| BaO | 0 to 6 wt % | 0.5 to 5.5 wt % | 1 to 4.5 wt % | 1.5 to 3.5 wt % |
| P₂O₅ | 0 to 4 wt % | 7 to 19 wt % | 0.5 to 3.5 wt % | 0.5 to 2.5 wt % |

It is believed, without being bound to any particular theory, that BaO exhibits an affinity to Li₂O and thereby functions as a Li₂O wetting agent. It is further believed that F₂ functions as both a wetting compound and as a component of the self-healing recrystallization phase of apatite or fluoroapatite as described herein. It is yet further believed that V₂O₅ improves the wetting properties of the glass composite systems of the present disclosure. V₂O₅ may be used in glass coating systems when the substrate is aluminum. It is believed that vanadium allows aluminum to go into solution and thereby form a bond with the glass composite.

In some aspects of the disclosure, the glass coating system comprises F₂. In some other aspects of the disclosure, the glass coating system comprises (i) F₂ and (ii) V₂O₅, BaO, or a combination thereof.

In some further aspects, the glass coating system may further comprise from about 0 to about 6 wt %, from about 0.2 to about 5 wt %, from about 0.2 to about 3 wt %, or from about 0.5 to about 2.5 wt % K₂O, wherein the concentration ranges refer to the final concentration in the glass coating system from which the glass composite is formed. It is believed, without being bound to any particular theory, that K₂O functions as an alkali equilibrium stabilizer, and may be useful when the glass coating system is applied to a substrate by electrostatic powdering.

In other aspects of the present disclosure, the glass coating system may further comprise a source of phosphate ions that react with calcium and recrystallize at ambient temperature in an alkaline environment. Under one theory, and without being bound by any particular theory, it is believed that the high lithium content of the glass composites of the present disclosure produces sufficient alkalinity for the reaction. Based on experimental evidence to date, and without being bound to any particular theory, it is further believed the glass coatings herein are at least partially soluble such that the PO₄⁻ ions and Ca²⁺ ions may contact and react. Phosphate- and calcium-ion reaction products include apatite, fluoroapatite and/or hydroxyapatite. Without being bound to any particular theory it is believed that apatite, fluoroapatite and/or hydroxyapatite function as nucleation agents. Sources of phosphate ions include phosphate salts or oxides, such as, for instance, P₂O₅. Calcium ions can be supplied by components in the glass coating systems as described herein and/or may be externally supplied by concrete encasing or otherwise in contact with the glass composite. Glass composite compositions formed from glass coating systems comprising those compounds are characterized by self-sealing properties. For instance, reinforced concrete containing ferrous rebar and/or structural steel substrate coated with the glass composite compositions of the present disclosure would expose the rebar and/or structural steel ferrous rebar to environmental conditions upon cracking. In response, the glass composite composition expands and recrystallizes by formation of reaction products between the phosphate and calcium ions thereby functioning to seal the crack. Such a seal serves to inhibit ingress of corrosive materials (e.g., deicing salts or sea water) into the crack and thereby minimize rebar and/or structural steel corrosion. In some aspects, the glass coating system includes from about 0.5 wt % to about 3.5 wt %, from about 0.5 wt % to about 3 wt %, or from about 0.5 wt % to about 2.5 wt % P₂O₅, wherein the concentration ranges refer to the final concentration in the glass coating system from which the glass composite is foimed. In some other aspects, the P₂O₅ content in the glass coating system is from about 7 to about 19 wt %.

In other aspects of the present disclosure, the glass coating system may further include a source of calcium. Suitable calcium sources include refractory cement, wollastonite, calcium carbonate, calcium silicate, calcium titanate, calcium phosphate, tricalcium phosphate, tricalcium silicate, and dicalcium phosphate. Such glass coating systems are particularly useful in concrete applications, such as where rebar or a steel substrate is coated with the glass composite compositions are used in combination with concrete to form a reinforced concrete structure. It is believed, without being bound to any particular theory, that the calcium compounds form bonds with the concrete matrix thereby enhancing the overall strength of any formed reinforced concrete structure. It is further believed, without being bound to any particular theory, that the calcium (whatever its addition form) is not fully solubilized and consequently remains as active nuclei in the coating layer wherein it may react with the surrounding concrete. It is still further believed that wollastonite and calcium titanate function as nucleation agents. In any of these various aspects of the present disclosure, the total concentration of calcium compounds as a fraction of the glass coating system or total glass composite weight is about 15 wt %, about 20 wt %, about 25 wt % or about 30 wt %, and ranges thereof, such as from about 15 wt % to about 30 wt % or from about 20 wt % to about 25 wt %.

In some aspects of the disclosure, the glass coating system comprises CaO, cement, wollastonite, calcium carbonate, calcium silicate, calcium titanate, calcium phosphate, tricalcium phosphate, tricalcium silicate, dicalcium phosphate or a combination thereof. In some other aspects, the glass coating system comprises CaO, wollastonite, calcium silicate, calcium titanate, calcium phosphate, tricalcium phosphate, tricalcium silicate or a combination thereof.

In some further aspects of the disclosure, the glass coating system may further comprise, or the glass coating system may be combined with a secondary fit or powder comprising, one or more compounds providing biocidal capabilities against organisms including fungi, algae, mollusks, bacteria, and combinations thereof. The compounds provide for coated articles having improved anti-fouling capabilities as compared to a coated article not containing such a compound. Suitable compounds include silver and zinc salts and oxides. In any of these various aspects of the present disclosure, the total concentration of the biocidal compounds is suitably from about 0.05 wt % to about 2.5 wt %, from about 0.1 wt % to about 2.5 wt %, from about 0.1 to about 2 wt %, or from about 0.1 to about 1 wt %. It is believed, without being bound to any particular theory, that nanomeric compounds provide biocidal capabilities at lower concentrations than micromeric materials.

As described herein, the glass coating system may suitably comprise the components listed in Table A in combination with one or more compounds selected from (i) alkali metal compounds capable of forming or enhancing a bond with iron oxides, (ii) one or more compounds capable of providing resistance to water and/or to alkali, (iii) one or more compounds capable of providing acid resistance properties, (iv) one or more wetting compounds, (v) a source of phosphate ions and/or (vi) a source of calcium.

In some further aspects of the present disclosure, instead of formulating all of the components in a frit or powder, a primary fit or powder may be combined with one or more secondary frits or powders comprising, but not limited to, one or more of elements (i) to (vi) above. For instance, (i) a primary fit or powder may be combined with a secondary frit or powder comprising one or more alkali metal compounds, (ii) a primary frit or powder may be combined with a secondary frit or powder comprising one or more sources of calcium, or (iii) a primary frit or powder may be combined with a first secondary frit or powder comprising one or more alkali metal compounds and a second secondary frit or powder comprising one or more sources of calcium.

In one particular aspect, a primary fit or powder may be combined with about 15 to about 35 wt % or from about 20 to about 22 wt % of a specific frit or powder characterized by high relative content, as compared to the primary frit or powder, of Li₂O, F₂, CaO and MoO₃ and a low relative SiO₂ content. In one such aspect, the secondary frit or powder may suitably comprise from about 20 to about 37 wt % SiO₂, from about 3.5 to about 6.5 wt % MoO₃, from about 7 to about 14.5 wt % Li₂O, from about 4.5 to about 9.5 wt % F₂, from about 9 to about 18 wt % CaO, from about 7 to about 16 wt % B₂O₃ and from about 4 to about 8.5 wt % BaO.

In another aspect, a primary frit or powder may be combined with a phosphate doped secondary frit or powder. In another aspect, a primary frit or powder may be combined with a secondary frit or powder comprising from about 1.2 to about 5 wt % CoO, from about 2 to about 6.5 wt % MnO, from about 1.2 to about 4.5 wt % NiO, from about 0.5 to about 1.2 wt % Sb₂O₃ and from about 0.5 to about 3 wt % CeO₂.

Example Compositions

As explained herein, the compositions of the various glass coating systems and resulting glass composite compositions of the present disclosure may suitably vary with the substrate and desired functional properties. Some non-limiting examples of various glass coating systems and glass composite compositions within the scope of the present disclosure are as follows.

TABLE E
Example Composition 1

| Component | First Range | Second Range | Third Range |
|---|---|---|---|
| CaO | 0.5 to 8.5 wt % | 1.5 to 7 wt % | 2 to 5 wt % |
| Na₂O | 4 to 22 wt % | 6 to 18 wt % | 7.5 to 16 wt % |
| Li₂O | 1 to 7 wt % | 1.5 to 4 wt % | 2 to 3.5 wt % |
| CoO | 0.2 to 5 wt % | 0.2 to 4 wt % | 0.4 to 3 wt % |
| NiO | 0.05 to 5 wt % | 0.05 to 3.5 wt % | 0.05 to 2.8 wt % |
| B₂O₃ | 5 to 21 wt % | 6 to 16 wt % | 7 to 13.5 wt % |
| F₂ | 0.5 to 8.5 wt % | 0.5 to 6 wt % | 0.7 to 5 wt % |
| SiO₂ | 46 to 65 wt % | 49 to 61 wt % | 52 to 58 wt % |
| Al₂O₃ | 0.1 to 3 wt % | 0.1 to 1.8 wt % | 0.1 to 1 wt % |
| TiO₂ | 3 to 9 wt % | 3 to 6.5 wt % | 3 to 6 wt % |
| ZrO₂ | 0.5 to 9 wt % | 0.5 to 5.5 wt % | 0.5 to 5 wt % |
| P₂O₅ | 0.5 to 3.5 wt % | 0.5 to 3 wt % | 0.5 to 2.5 wt % |

TABLE F
Example Composition 2.

| Component | First Range | Second Range | Third Range |
|---|---|---|---|
| Al₂O₃ | 0.1 to 3.0 wt % | 0.1 to 1.8 wt % | 0.1 to 1 wt % |
| B₂O₃ | 5.0 to 21 wt % | 6.0 to 16 wt % | 7.0 to 13.5 wt % |
| BaO | 0.5 to 5.5 wt % | 1.0 to 4.5 wt % | 1.5 to 3.5 wt % |
| CaO | 0.5 to 8.5 wt % | 1.5 to 7.0 wt % | 2.0 to 5.0 wt % |
| CoO | 0.2 to 5.0 wt % | 0.2 to 4.0 wt % | 0.2 to 3.0 wt % |
| F₂ | 0.5 to 8.5 wt % | 0.5 to 6.0 wt % | 0.7 to 5.0 wt % |
| K₂O | 0.2 to 5.0 wt % | 0.2 to 3.0 wt % | 0.5 to 2.5 wt % |
| Li₂O | 1.0 to 5.5 wt % | 1.5 to 3.8 wt % | 2.0 to 3.5 wt % |
| MnO | 0.2 to 6.0 wt % | 0.5 to 4.8 wt % | 0.8 to 3.5 wt % |
| MoO₃ | 0.2 to 5.0 wt % | 0.5 to 4.5 wt % | 0.5 to 4 wt % |
| Na₂O | 4.0 to 22 wt % | 6.0 to 18 wt % | 7.5 to 16 wt % |
| NiO | 0.05 to 5.0 wt % | 0.05 to 3.5 wt % | 0.05 to 2.8 wt % |
| P₂O₅ | 0.5 to 2.5 wt % | 0.5 to 3.0 wt % | 0.5 to 2.5 wt % |
| SiO₂ | 46 to 65 wt % | 49 to 61 wt % | 52 to 58 wt % |
| TiO₂ | 3.0 to 7.0 wt % | 3.0 to 6.5 wt % | 3.0 to 6.0 wt % |
| ZrO₂ | 0.5 to 6.0 wt % | 0.5 to 5.5 wt % | 0.5 to 5.0 wt % |

TABLE G
Example Composition 3

| Component | First Range | Second Range | Third Range |
|---|---|---|---|
| Na₂O | 4 to 22 wt % | 6 to 18 wt % | 7.5 to 16 wt % |
| Li₂O | 1 to 6 wt % | 1.5 to 4 wt % | 2 to 3.5 wt % |
| B₂O₃ | 5 to 21 wt % | 6 to 16 wt % | 7 to 13.5 wt % |
| SiO₂ | 46 to 65 wt % | 49 to 61 wt % | 52 to 58 wt % |
| CoO | 0.2 to 5 wt % | 0.2 to 4 wt % | 0.4 to 3 wt % |
| MnO | 0.2 to 6.5 wt % | 0.5 to 4.8 wt % | 0.8 to 3.5 wt % |
| NiO | 0.05 to 5 wt % | 0.05 to 3.5 wt % | 0.05 to 2.8 wt % |
| Sb₂O₃ | 0.05 to 2 wt % | 0.05 to 1.5 wt % | 0.1 to 1 wt % |
| CeO₂ | 0.1 to 3.5 wt % | 0.3 to 3 wt % | 0.5 to 2.8 wt % |

Example composition 4 includes: 0 to 4 wt % BaO; 2 to 30 wt % CaO; 0 to 4 wt % SrO; 0 to 4 wt % MgO; 6 to 22 wt % Na₂O; 0 to 5 wt % K₂O; 1 to 13 wt % Li₂O; 0.5 to 7 wt % CoO; 0 to 3 wt % CuO; 0 to 7 wt % Fe₂O₃; 0 to 9 wt % MnO; 0.1 to 6 wt % NiO; 0 to 9 wt % MoO₃; 0 to 3 wt % Sb₂O₃; 5 to 22 wt % B₂O₃; 1 to 5 wt % F₂; 24 to 61 wt % SiO₂; 0.5 to 9 wt % Al₂O₃; 0.5 to 14 wt % TiO₂; 0 to 3 wt % ZnO; 1 to 8 wt % ZrO₂; 4 to 30 wt % P₂O₅; and <4 wt % CeO₂, La₂O₃, V₂O₅, and WO₃.

Example composition 5 is a soft coating including: less than about 40 wt % SiO₂; greater than about 20 wt % B₂O₃; greater than about 18 wt % Na₂O; from about 4 wt % to about 7 wt % Li₂O; and from about 3 wt % to about 6 wt % MoO₃.

Glass Coating System Preparation

Any of the various fit or powder compositions making up the glass coating systems within the scope of the present disclosure may be prepared according to a variety of methods. In a first method, the glass coating system may be prepared by combining the primary frit or powder components with additional components followed by blending thereof, melting to form the frit, and particle size reduction. In a second method, primary frit powder may be admixed with the additional components to form a dry blend thereof. Optionally, the blended admixture may be subjected to particle size reduction in order to provide a blend having a relatively uniform particle size distribution. In a third method, the primary frit or powder may be combined with the additional components in a slurry admixture. In a fourth method, additive frits or powder mixtures may be formed, according to the methods disclosed herein, from the components providing alkali resistance, from the components providing acid resistance, from the components providing enhanced bonding strength for reinforced concrete structures, from the components providing for porcelain enamel formation in the absence of substrate preparation, from the components providing for self-sealing cracks in reinforced concrete structures, and/or from the components providing for algaecide, fungicide and/or biocide capabilities. In such aspects, the primary frit or powder may be admixed by blending with one or more additive frits, and optionally subjected to particle size reduction, to form a blended frit or powder for glass composite and/or porcelain enamel formation.

Glass Composite and Porcelain Enamel Formation

Glass coating systems of the present disclosure may be applied to substrates by various methods known to those skilled in the art of applying coatings, from frits or powders or other initial forms, such as by wet processes, flow coating, electrophoretic deposition, electrostatic powder deposition, powder electrostatic enameling, and centrifugal enameling. It will be appreciated that any number of these various enameling methods, or other methods known in the art, may be adapted for use within the broad general scope of the present disclosure.

Many coating systems may only be applied successfully by one or two particular methods, such as wet spraying. However, coating systems disclosed herein have been found to be suitable for use in several or all of the methods noted above, such that the compositions disclosed herein may be used in association with a broader range of substrates, allowing glass composite coatings to be used in many new fields of interest.

For example, glass composite coatings according to embodiments herein may be used in various oilfield applications, both internal and external to piping or other portions of drill strings and associated oilfield equipment, as well as pipelines used to transport oil and natural gas across large distances; similarly, application in various petrochemical industries may be envisioned. Used internally, the glass composite coatings may reduce exposure of a substrate, such as steel, to H₂S and other harmful components contained in crude oil and natural gas that may reduce the useful life of the substrate. Used internally and externally, such glass composite coatings may reduce abrasion, friction, heat, and wear, due to added lubricity provided by the coating. Used externally, for example, such glass composite coatings may provide thermal insulation and protection against environmental exposure. For example, coatings according to embodiments herein may have one or more of a Hazen-Williams coefficient (measure of lubricity) in the range from about 140 to about 160, a corrosion resistance in environments where the pH may range from 3 to 10, a hardness on the Mohs seal of 6+ and a Rockwell exceeding 73 (both reflecting abrasion resistance), a temperature resistance exhibited by maintaining most properties up to about 430° C., and thermal shock resistance, such as tolerating instantaneous temperature changes exceeding 180° C.

In some aspects of the present disclosure, the glass coating systems can be electrostatically sprayed onto metallic substrate surfaces. The coated substrate may then be fused so as to form a layer on the substrate by exposure to high temperature or by firing. Electrostatic porcelain enamel powder application is known in the art and is disclosed in assorted publications, for instance, U.S. Pat. Nos. 3,928,668, 3,930,062, 4,059,423, 4,063,916, 4,082,860, 4,476,156, 5,100,451, 5,213.598, 5,393,714, 5,534,348, 5,589,222, 6,270,854, 6,350,495, 6,517,904, 6,800,333 and 6,831,027. See also “Manual of Electrostatic Porcelain Enamel Powder Application,” (1997), Porcelain Enamel Institute, Nashville, Tenn.

In some other aspects, in a wet method, a slurry is formed from one or more glass coating systems of the present disclosure. The slurry can suitably be formed using an aqueous carrier medium, an organic carrier medium (e.g., methanol, ethanol, ethyl acetate) or a combination thereof. In some aspects of the present disclosure, a wetting agent may be added to the slurry to facilitate even slurry distribution on the substrate surface, such as when the substrate includes a coating of film of oil or grease. Examples of suitable wetting agents include Tego® Wet 250 and Tego® Wet 500 available from EVONIK Industries. The slurries may optionally additionally include electrolytes and clays to assist in maintaining the frit or powder in suspension. Suitable glass frit or powder slurry concentration is 10 wt %, 20 wt %, 30 wt %, 40 wt % or 50 wt %, and ranges thereof. The slurry can be applied to the substrate by spraying the slurry onto the substrate or by dipping the substrate into the slurry. After application, the slurry is dried to form a coating. In some aspects of the present disclosure, one or more additional glass coatings can be applied by additional soaking or by additional electrostatic application steps. After coating, the substrate is heat treated to sinter and crystallize the glass coating to form a fused layer on the substrate. The heat treatment may include conventional firing or may be an induction based heat treatment, for example. Induction furnaces may advantageously reduce the heat treatment time, such as to less than 1 minute in some embodiments, and may thus advantageously allow the properties of the substrate to remain largely unaffected, such as the crystalline structure of the metal and other desirable properties of the metal that may be affected by heat treatments.

In some other aspects of the present disclosure, in a flow coat method, where the substrate is processed through a dipping operation, the part is immersed in the “slip”, the part is removed from the immersion, and the slip is allowed to drain off. The slip is flowed over the part and the excess is allowed to drain off. A uniform coating is achieved by controlling the density of the porcelain enamel slip and the positioning of the part.

In other aspects, in an electrophoretic (EPE) method, the substrate is processed in a dipping operation where electric power is used to deposit enamel material on a substrate surface. Electrophoretic application of porcelain enamel coatings to substrates is known in the art and is disclosed in assorted publications, for instance, U.S. Pat. Nos. 5,002,903, 4,085,021 and 3,841,986.

In any of the various application methods, heat treating can be done by firing in an oven or furnace, or by electrical resistivity. In general, a temperature of at least about 600° C., at least about 650° C., at least about 700° C., at least about 750° C., at least about 800° C., at least about 850° C. or at least about 900° C., and ranges thereof, is used for heat treatment. In some aspects, heating can be done in an inert atmosphere, such as argon, helium or nitrogen. In some other aspects, multiple heat treatment cycles can be used. The heat treatment may be at a temperature sufficient to create both a mechanical and a chemical/molecular bonding layer between the glass composite lining and the substrate. As noted above, glass coating systems and compositions herein may be applied and bonded without the need for pre-treatment, and in some embodiments, the formation of the bond may be enhanced by the presence of surface imperfections.

In yet other embodiments, glass coating systems disclosed herein may also include fibers, such as glass fibers, ceramic fibers, and metal fibers. The inclusion of fibers in the glass coating system may enhance the elasticity of the resulting glass composite, provide a dielectric or conductive layer, or enhance insulating properties, among other benefits.

As described above, embodiments disclosed herein provide for glass coating systems and resulting glass composite coatings that may serve as a chemical barrier against substrate oxidation or other deterioration by corrosive agents, may prevent material build-up in process piping and equipment, may provide for improved bonding strength between concrete and reinforcing media, and may inhibit microbial build-up on exposed surfaces. Advantageously, such glass coating systems may be bonded to non-treated substrates, without detriment to the bonding and performance of the coating system with the substrate. Further, embodiments disclosed herein provide for coating systems that may be formed from two or more frits or powders, where the primary frit or powder and secondary frit(s) or powder(s) may be used to enhance the bonding effect with the substrate, as well as to provide the desired surface properties of the coating, such as improved chemical resistance, self-healing, or bonding with concrete, for example.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

1. A process for emplacing a glass coating on a substrate, the process comprising:
applying a glass coating system to at least one surface of a non-treated substrate;
at least one of admixing a primary frit or powder with a secondary frit or powder to form the glass coating system, or applying a secondary frit or powder composition to a surface formed by the glass coating system after the applying step;
at least one of admixing a second secondary frit or powder or applying a second secondary frit or powder to a surface formed by the secondary frit or powder composition;
sintering the glass coating system to form a glass coating therefrom on the at least one surface of the substrates;
wherein the second secondary frit comprises from about 7 wt % to about 19 wt % P₂O₅.

2. (canceled)

3. (canceled)

4. (canceled)

5. (canceled)

6. The process of claim 1, wherein the glass coating system is formed by admixing:
from about 5 wt % to about 21 wt % B₂O₃;
from about 1 wt % to about 7 wt % Li₂O;
from about 4 wt % to about 22 wt % Na₂O; and
from about 46 wt % to about 65 wt % SiO₂.

7. The process of claim 6, further comprising admixing at least one of CoO, MnO, NiO, CeO₂, CuO and MoO₃, wherein when used:
the CoO concentration is from about 0.2 wt % to about 5 wt %;
the MnO concentration is from about 0.2 wt % to about 6.5 wt %;
the NiO concentration is from about 0.05 wt % to about 5 wt %;
the CeO₂ concentration is from about 0.1 wt % to about 3.5 wt %;
the CuO concentration is from about 0.1 wt % to about 3.5 wt %; and
the MoO₃ concentration is from about 0.2 wt % to about 6 wt %.

8. The process of claim 6, further comprising admixing at least one of Al₂O₃, CaO, ZrO₂, Fe₂O₃ and ZnO, wherein when used:
the Al₂O₃ concentration is from about 0.1 wt % to about 3 wt %;
the CaO concentration is from about 0.5 wt % to about 8.5 wt %;
the ZrO₂ concentration is from about 0.5 wt % to about 9 wt %;
the Fe₂O₃ concentration is from about 0.1 wt % to about 5.5 wt %; and
the ZnO concentration is from about 0.1 wt % to about 3 wt %.

9. The process of claim 6, further comprising admixing at least one of F₂ and V₂O₅, wherein when used:
the F₂ concentration is from about 0.5 wt % to about 8.5 wt %; and
the V₂O₅ concentration is from about 0.1 wt % to about 5 wt %.

10. The process of claim 6, further comprising admixing at least one of Sb₂O₃ and WO₃, wherein when used:
the Sb₂O₃ concentration is from about 0.05 wt % to about 2 wt %; and
the WO₃ concentration is from about 0.1 wt % to about 3.5 wt %.

11. The process of claim 6, further comprising admixing at least one of BaO, K₂O, and P₂O₅, wherein when used:
the BaO concentration is from about 0.5 wt % to about 5.5 wt %;
the K₂O concentration is from about 0.2 wt % to about 5 wt %; and
the P₂O₅ concentration is from about 0.5 wt % to about 3.5 wt %.

12. (canceled)

13. The process of claim 1, wherein the glass coating comprises from about 15 wt % to about 35 wt % of the secondary frit.

14. (canceled)

15. (canceled)

16. A glass composite or glass coating system comprising:
(1) from about 5 wt % to about 21 wt %, from about 6 wt % to about 16 wt %, or from about 7 wt % to about 13.5 wt % B₂O₃,
(2) from about 1 wt % to about 7 wt %, from about 4 wt % to about 7 wt %, from about 1 wt % to about 6.5 wt %, from about 2.5 wt % to about 6.5 wt %, from about 3.5 to about 6.5 wt %, from about 1.5 wt % to about 4 wt %, or from about 2 wt % to about 3.5 wt % Li₂O,
(3) from about 4 wt % to about 22 wt %, from about 6 wt % to about 18 wt %, or from about 7.5 wt % to about 16 wt % Na₂O and
(4) from about 46 wt % to about 65 wt %, from about 49 wt % to about 61 wt %, from about 54 wt % to about 61 wt %, or from about 52 wt % to about 58 wt % SiO₂.

17. The composition of claim 16 further comprising from about 3 wt % to about 9 wt %, from about 4.5 wt % to about 9 wt %, from about 3 wt % to about 6.5 wt %, or from about 3 wt % to about 6 wt % TiO₂, wherein TiO₂ provides acid resistance properties.

18. The composition of claim 16, further comprising at least one compound capable of forming a bond with FeO, the compound selected from CoO, MnO, NiO, CeO₂, CuO and MoO₃, wherein when used:
(1) the CoO concentration is from about 0.2 wt % to about 5 wt %, from about 0.2 wt % to about 4 wt %, or from about 0.4 wt % to about 3 wt %,
(2) the MnO concentration is from about 0.2 wt % to about 6.5 wt %, from about 0.5 wt % to about 4.8 wt %, or from about 0.8 wt % to about 3.5 wt %,
(3) the NiO concentration is from about 0.05 wt % to about 5 wt %, from about 0.05 wt % to about 3.5 wt %, or from about 0.05 wt % to about 2.8 wt %,
(4) the CeO₂ concentration is from about 0.1 wt % to about 3.5 wt %, from about 0.3 to about 3 wt %, or from about 0.5 wt % to about 2.8 wt %,
(5) the CuO concentration is from about 0.1 wt % to about 3.5 wt %, from about 0.3 to about 3 wt %, or from about 0.5 wt % to about 2.2 wt %, and
(6) the MoO₃ concentration is from about 0.2 wt % to about 6 wt %, from about 0.2 wt % to about 5 wt %, from about 3 wt % to about 6 wt %, from about 0.5 wt % to about 4.5 wt %, or from about 0.5 wt % to about 4 wt %.

19. The composition of claim 16, further comprising at least one compound providing resistance to water and/or alkali, the compound selected from Al₂O₃, CaO, ZrO₂, Fe₂O₃ and ZnO, wherein when used:
(1) the Al₂O₃ concentration is from about 0.1 wt % to about 3 wt %, from about 0.5 wt % to about 3 wt %, from about 0.1 wt % to about 1.8 wt %, or from about 0.1 wt % to about 1 wt %,
(2) the CaO concentration is from about 0.5 wt % to about 8.5 wt %, from about 1.5 wt % to about 7 wt %, or from about 2 wt % to about 5 wt %,
(3) the ZrO₂ concentration is from about 0.5 wt % to about 9 wt %, from about 2 wt % to about 9 wt %, from about 0.5 wt % to about 5.5 wt %, or from about 0.5 wt % to about 5 wt %,
(4) the Fe₂O₃ concentration is from about 0.1 wt % to about 5.5 wt %, or from about 0.6 wt % to about 4.2 wt %, and
(5) the ZnO concentration is from about 0.1 wt % to about 3 wt % or from about 0.5 wt % to about 2.2 wt %.

20. The composition of claim 16, further comprising at least one wetting compound selected from F₂ and V₂O₅, wherein when used (i) the F concentration is from about 0.5 wt % to about 8.5 wt %, from about 0.5 to about 6 wt % or from about 0.7 wt % to about 5 wt %, and (ii) the V₂O₅ concentration is from about 0.1 wt % to about 5 wt % or from about 2 wt % to about 5 wt %.

21. The composition of claim 16, wherein the Ni concentration is less than about 1 wt %, less than about 0.5 wt %, less than about 0.1 wt %, or wherein the composition has an essential absence of Ni, and the composition further comprises from about 0.1 to about 5.5 wt % or from about 0.6 wt % to about 4.2 wt % Fe₂O₃.

22. The composition of claim 16, further comprising a compound capable of enhancing a chemical bond with FeO, the compound selected from Sb₂O₃ and WO₃ wherein (i) the Sb₂O₃ concentration is from about 0.05 wt % to about 2 wt %, from about 0.05 wt % to about 1.5 wt %, or from about 0.1 wt % to about 1 wt % and (ii) the WO₃ concentration is from about 0.1 wt % to about 3.5 wt %, from about 0.1 wt % to about 3 wt %/o, or from about 0.5 wt % to about 2.8 wt %.

23. The composition of claim 16, further comprising from about 0.5 wt % to about 5.5 wt %, from about 1 wt % to about 4.5 wt %, or from about 1.5 wt % to about 3.5 wt % BaO, wherein BaO is a Li₂O wetting agent.

24. The composition of claim 16, further comprising from about 0.2 wt % to about 5 wt %, from about 0.2 wt % to about 3 wt %, or from about 0.5 wt % to about 2.5 wt % K₂O, wherein K₂O is an alkali equilibrium stabilizer.

25. The composition of claim 16, further comprising from about 0.5 wt % to about 3.5 wt %, from about 0.5 wt % to about 3 wt %, from about 0.5 wt % to about 2.5 wt %, or from about 7 to about 19 wt % P₂O₅.

26. (canceled)

27. The composition of claim 16, comprising:
(1) from about 5 wt % to about 21 wt % B₂O₃,
(2) from about 1 wt % to about 6 wt % Li₂O,
(3) from about 4 wt % to about 22 wt % Na₂O,
(4) from about 46 wt % to about 65 wt % SiO₂,
(5) from about 1.2 wt % to about 5 wt % CoO,
(6) from about 2 wt % to about 6.5 wt % MnO,
(7) from about 1.2 wt % to about 4.5 wt % NiO,
(8) from about 0.5 wt % to about 1.2 wt % Sb₂O₃, and
(9) from about 0.5 wt % to about 3 wt % CeO₂.

28. The composition of claim 16, further comprising at least one compound providing a source of calcium, the composition comprising from about 15 wt % to about 30 wt % or from about 20 wt % to about 25 wt % of compounds providing a source of calcium.

29. (canceled)

30. The composition of claim 16, wherein the composition comprises from about 4 wt % to about 7 wt % Li₂O and from about 3 wt % to about 6 wt % MoO₃.

31. The composition of claim 16, wherein the weight ratio of Li₂O to SiO₂ is from about 0.01:1 to about 0.2:1, from about 0.015:1 to about 0.15:1, from about 0.02:1 to about 0.08:1, or from about 0.03:1 to about 0.07:1.

32. The composition of claim 16, where the composition is a primary frit or powder having an average particle size of from about 10μ to about 100μ.

33. A glass composite composition formed from at least two frits or powders comprising a primary frit or powder and a first secondary frit or powder, wherein
(1) the primary flit or powder corresponds to the composition of claim 16, and
(2) the first secondary frit or powder has an average particle size of from about 10μ to about 100μ and comprises
(a) from about 37 wt % to about 48 wt % SiO₂,
(b) from about 1.5 wt % to about 5 wt % MoO₃,
(c) from about 3 wt % to about 11 wt % Li₂O,
(d) from about 2 wt % to about 7 wt % F₂,
(e) from about 4 wt % to about 8.5 wt % CaO, and
(f) from about 5 wt % to about 14 wt % B₂O₃, and
wherein the glass composite composition comprises from 15 wt % to about 35 wt % or from about 20 wt % to about 22 wt % of the first secondary frit or powder.

34. The composition of claim 33 further comprising a second secondary fit or powder, the second secondary frit or powder comprising from about 7 wt % to about 19 wt % P₂O₅.

35. A coated article comprising a ferrous or non-ferrous substrate and a glass composite formed from the composition according to claim 16 deposited on at least one surface of the substrate.

36.-42. (canceled)

43. A method for coating a ferrous or non-ferrous substrate with a glass composite, the method comprising (i) applying a composition of claim 16 to at least one surface of a ferrous or non-ferrous substrate, and (ii) sintering the frit composition to form the glass composite therefrom on the at least one surface of the substrate.

44. (canceled)

45. (canceled)
